(19) United States
(12) Patent Application Publication
(10) Pub. No.: US 2009/0127199 A1
(43) Pub. Date: May 21, 2009

(54) METHOD AND DEVICE FOR FLUORIDE REMOVAL FROM DRINKING WATER

(75) Inventors: Sumeet Mehra, Mumbai (IN); Subhash Mehra, Mumbai (IN); Michael H. Francisco, Menlo Park, CA (US)

Correspondence Address: SCHNECK & SCHNECK, P.O. BOX 2-E, SAN JOSE, CA, 95109-0005, US

(73) Assignee: 350 CAMBRIDGE PARTNERS, LLC, Palo Alto, CA (US)

(21) Appl. No.: 12/251,235

(22) Filed: Oct. 14, 2008

Related U.S. Application Data
(60) Provisional application No. 60/979,157, filed on Oct. 11, 2007.

(51) Int. Cl. B01D 61/16; B01D 69/04

(52) U.S. Cl. 210/650; 210/500.23

(57) ABSTRACT

A water filtration device and method in which water is pumped through a chamber containing iron oxide particles or material, which allows removal of ionic contaminants, including fluoride. Water is then pumped through a plurality of ultrafilration tubes. The water enters the sides of the tubes into the tube interior and flows out of the open ends of the tubes. The sides and the ends of the tubes are separated by a water impermeable barrier.

### CROSS-REFERENCE TO RELATED APPLICATION

This application claims priority from provisional application Ser. No. 60/979,157, filed Oct. 11, 2007.

### TECHNICAL FIELD

The present invention relates to a method and device for removing fluoride from drinking water.

### BACKGROUND OF THE INVENTION

Potable (i.e., drinking) water is a necessity to which millions of people throughout the world have limited access. There is no standard for how much water a person needs each day, but experts usually put the minimum at 100 liters for adults. Most people drink two or three liters. The rest is typically used for cooking, bathing, and sanitation. Adult Americans consume between four hundred and six hundred liters of water each day.

By 2050, there will be at least nine billion people on the planet, the great majority of them in developing countries. If potable water were spread evenly across the globe, there might be enough for everyone. But rain often falls in the least desirable places at the most disadvantageous times. For example, some cities in India get fewer than forty days of rain each year—all in less than four months. Somehow, though, the country has to sustain nearly twenty percent of the Earth's population with four percent of its water. China has less potable water than Canada—and forty times as many people. With wells draining aquifers far faster than they can be replenished by rain, the water table beneath Beijing has fallen nearly two hundred feet in the past twenty years.

More than a billion people lack access to drinking water. Simply providing access to clean water could save two million lives each year. Nearly two billion people rely on wells for their water. There were two million wells in India thirty years ago; today, there are twenty-three million. As the population grows, the freshwater available to each resident dwindles, and people have no choice but to dig deeper. Drill too deep, though, and saltwater and arsenic can begin to seep in.

Water purification processes are well known and used throughout the world. Water purification is the removal of contaminants from untreated water to produce drinking water that is pure enough for human consumption. Substances that are removed during the process include parasites (such as Giardia or Cryptosporidium), bacteria, algae, viruses, fungi, minerals (including toxic metals such as lead, copper and arsenic), and man-made chemical pollutants. Many contaminants can be dangerous. Other contaminants are removed to improve the water's smell, taste, and appearance.

It is not possible to tell whether water is safe to drink just by looking at it. Simple procedures such as boiling or the use of a household charcoal filter are commonly used as a best practice for reducing risk in drinking water, but may not be sufficient for treating water from an unknown source. Even natural spring water—considered safe for all practical purposes in the 1800s—must now be tested before determining what kind of treatment is needed. Brackish water is water that has up to 2000-5000 ppm (parts per million) total dissolved solids (TDS). “Mildly” brackish water has a TDS of about 500 to 1000 ppm.

Fluoride is one of the chemical constituents found in water sources. Fluoride is found in all water sources at some concentration level. The amount of fluoride in groundwater or surface water may be low or high, depending on a number of factors. High fluoride concentrations are expected in groundwaters in calcium poor aquifers and in areas where fluoride releasing minerals are prevalent.

Fluorosis, the adverse health effects from excessive fluoride, is a significant problem in a number of developing countries including parts of India. According to a 1999 UNICEF report, 17 of the 32 states of India were found to have naturally occurring unhealthy levels of fluoride in their water sources. This included serious problems with elevated fluoride levels found in Gujarat, Tamil Nadu, and Punjab among others. This report found that Haryana water sources tested at 48 mg/l of fluoride.

Generally, fluoride from drinking water sources is the largest contributor to fluoride intake, especially in developing countries. The dose of fluoride is dependent on the amount of fluoride in the water and the amount of water consumed by each individual. In hot and humid countries, the amount of water consumed increases, increasing the fluoride dose. Equitorial countries are thus at greater risk for problems with fluoride consumption based in higher water consumption in these countries.

Excessive levels of fluoride lead to a number of adverse health effects. These include dental fluorodosis, which is characterized in degradation of dental enamel, and skeletal fluorosis, which can be characterized by skeletal deformity, calcification of ligaments, and osteosclerosis.

Acceptable drinking water specifications (IS:10500-1191) include the following recommended and “acceptable” levels: a TDS of 500 ppm (up to 2000 ppm, if no other source is available); 0.3 ppm iron (up to 1.0 ppm); 1.0 ppm fluoride (up to 1.5 ppm); 0.05 ppm arsenic; 0.03 ppm aluminum (up to 0.2 ppm); with a pH of 6.5-8.5.

There are many potential sources of water, though none is safe for drinking without prior treatment and purification. The water emerging from some deep groundwater may have fallen as rain many decades or even hundreds of years ago. Soil and rock layers naturally filter the groundwater to a high degree of clarity before it is pumped to the treatment plant. Such water may emerge as springs (e.g., artesian springs) or may be extracted from boreholes or wells. Deep groundwater is generally of very high bacteriological quality (i.e., a low concentration of pathogenic bacteria such as Campylobacter or the pathogenic protozoa Cryptosporidium and Giardia) but may be rich in dissolved solids, especially carbonates and sulfates of calcium and magnesium. Depending on the strata through which the water has flowed, other ions may also be present including chloride, and bi-carbonate. There may be a requirement to reduce the iron or manganese content of this water to make it pleasant for drinking and cooking. Disinfection is also required. Where groundwater recharge is practiced, it is equivalent to lowland surface waters for treatment purposes.

A method and device for simply removing fluoride from drinking water would be advantageous.

### SUMMARY

Embodiments of the present invention include a water filtration device in which water flows from a water intake into an enclosed chamber holding iron oxide material. The iron oxide material, such as oxidized iron ball bearings, iron particulate matter, mesh, or other iron material, is disposed within this chamber such that water flowing through the intake will flow through the iron oxide material, allowing ionic fluoride to react and form an insoluble percipitate. The water flowing through this chamber next flows through an ultrafiltration membrane (e.g., into an ultrafiltration membrane cartridge.) The cartridge contains a plurality of ultrafiltration membrane tubes disposed within a cartridge. Water flows through walls of the ultrafiltration membrane tubes, into an interior of said ultrafiltration tubes and out an open end of said ultrafiltration membrane tubes. The open ends are secured through a barrier layer that prevents unfiltered water from mixing with filtered water. Purified water then flows from an outlet from the cartridge on a side of the barrier layer having the open ultrafiltration membrane tubes ends.

In an associated method embodiment, water is first passed through a chamber having an iron oxide material to remove ionic contaminants. The water is then purified by ultrafiltration purification as above. The size of iron oxide materials (e.g., ball bearings, particles, ion mesh, etc.) could be selected based on the flow rate of water filtered, the concentration of fluoride in the water, or other factors.

### BRIEF DESCRIPTION OF THE DRAWINGS

FIG. 1 is a top view of an ultrafiltration membrane holding insert.

FIG. 2 is an exploded view of an ultrafiltration cartridge.

FIG. 3 is a cross sectional view of a cartridge with untrimmed ultrafiltration membranes.

FIG. 4 is a cross sectional view of a cartridge showing a single ultrafiltration membrane and a cartridge inlet and outlet.

FIG. 5 is a partial cross section of an embodiment of an ionic contaminant reducing embodiment.

FIG. 6 is a cross section of a fluoride removal water bottle embodiment.

FIG. 7 is a schematic of a fluoride removal hand pump embodiment.

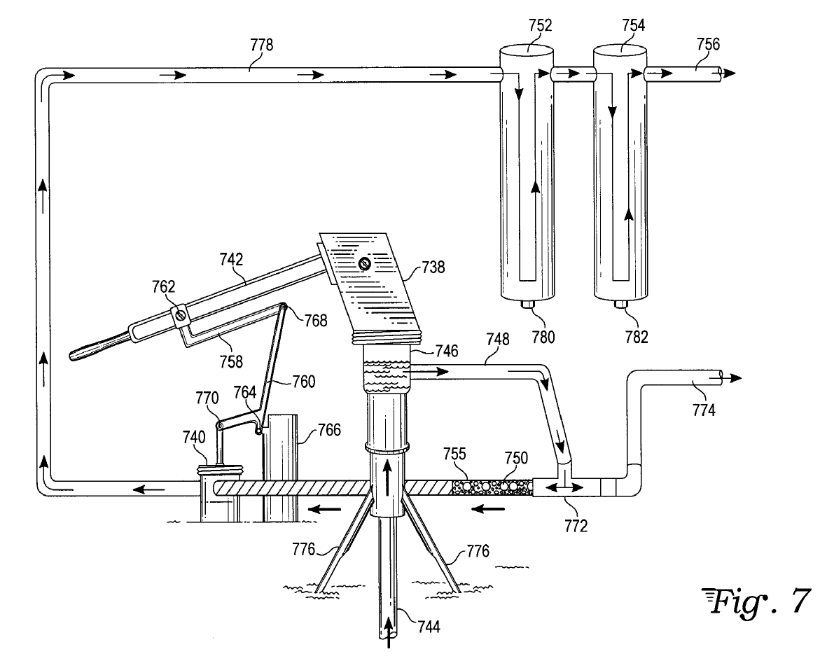

### DETAILED DESCRIPTION

### Ultrafiltration Cartridge

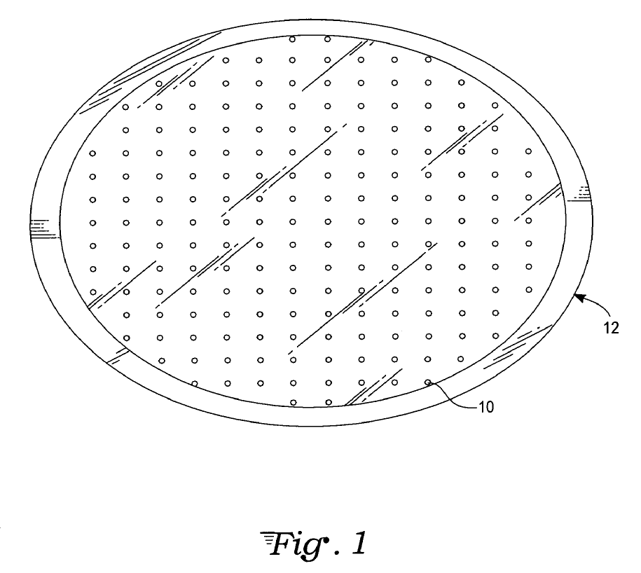

With reference to FIG. 1, an attachment disc 10 is shown for holding the ultrafiltration membranes. One end of each length of the ultrafiltration membrane is secured through holes 10.

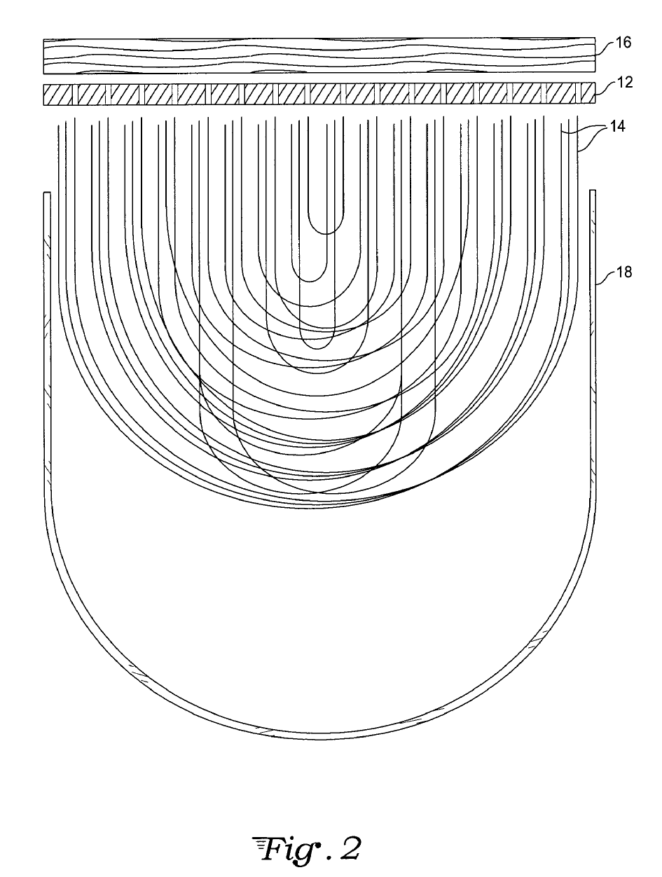

With respect to FIG. 2, the exploded view of a cross section of the cartridge includes the attachment disc 12 (as shown in Figure one) in cross section, and the ultrafiltration membrane tubes 14. These membranes may be made from Ultra-Flo DUC 108 ultrafiltration membrane from Ultra-Flo PTE Ltd., 452 Tasgore Industrial Avenue, Singapore 787823.

The ends of the membranes are secured into potting compound 16. The attachment disc 12 is secured onto the side of cartridge housing 18. The filter holding structure may be a plastic clip fused to the cartridge bell housing.

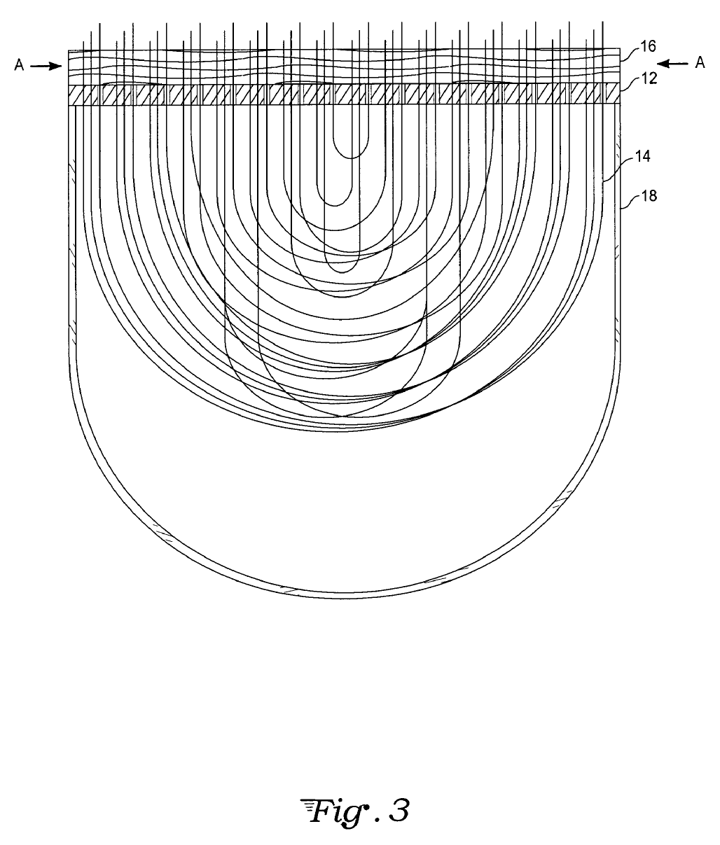

With respect to FIG. 3, a cross sectional view is shown including an attachment disc 12 secured onto the inner sides of housing 18. The ultrafiltration membrane tubes each have two ends, each of which extend through the attachment disc 12 and the potting material 16. The process of manufacture include the following steps:

1. The ultrafiltration membrane tubes are cut to the proper length.
2. The ends of the ultrafiltration membrane tubes are secured to the attachment disc.
3. The attachment disc is secured to the housing of the cartridge.
4. The potting material is added to the top side of the attachment disc.
5. A centrifugal force is applied to the potting material. This ensures that the potting material is distributed evenly, and that all of the ultrafiltration membrane tubes are secured at the ends.
6. The potting material is cut along lines A of FIG. 3. The excess material is removed. This leaves a level top surface which has the openings of the ultrafiltration membrane tubes. Because the tubes extend beyond the potting material, the potting material does not clog the ends of the tubes.
7. A top is secured onto the cartridge to provide an upper chamber into which filtered water flows. This top may be secured by threads, allowing the cartridge to be partially disassembled.

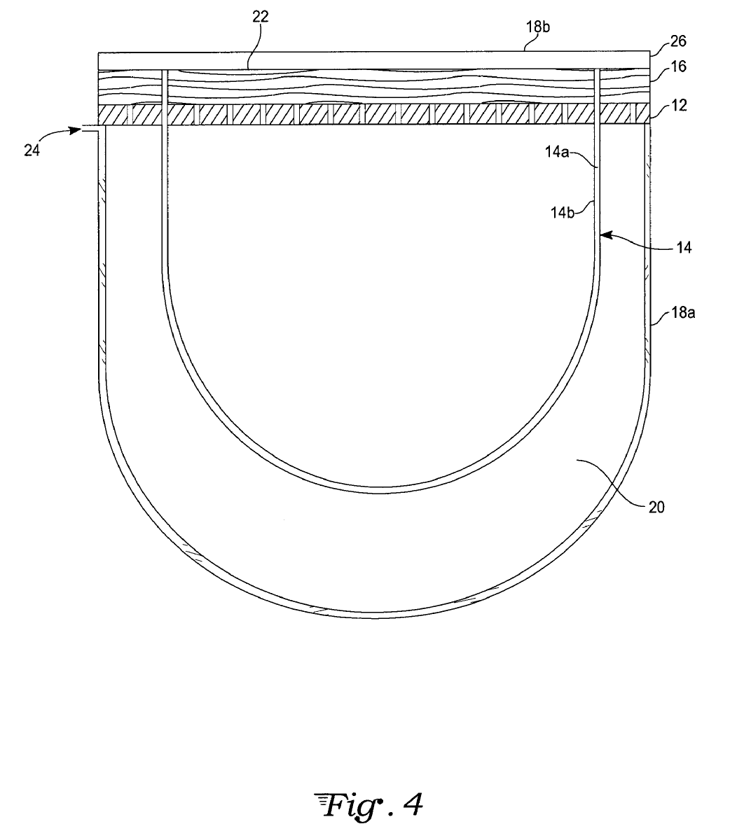

With reference to FIG. 4, a cross section of a filter cartridge shows a single ultrafiltration membrane tube 14 secured into an attachment disc 12 and potted into potting compound 16. The open ends of the ultrafiltration membrane tube 14. The ends of the ultrafiltration membrane tube 14 open into an upper cartridge chamber 22 defined by lid 18b of housing 18. Upper cartridge camber 22 has an outlet 26. This outlet may have flow regulated by a valve. The lower cartridge chamber 20 defined by housing 18a has an inlet chamber 24. The flow through the cartridge is through opening 24 and into lower cartridge camber 20. The water would then pass through the pores of the ultrafiltration membrane and into the interior 14a of ultrafiltration membrane tube 14. The contaminants larger than the pore size of the ultrafiltration membrane would be retained on the exterior of the ultrafiltration membrane tube. These contaminants would be retained within lower cartridge chamber 20 and could be removed by backflushing the cartridge is reduced flow rates are observed. Both the inlet and the outlet could have coupling members, such as external threads, to allow attachment of the cartridge to other devices. In addition, the inlet 24 and outlet 26 could have valves to regulate flow.

### Fluoride Filtration Devices and Method

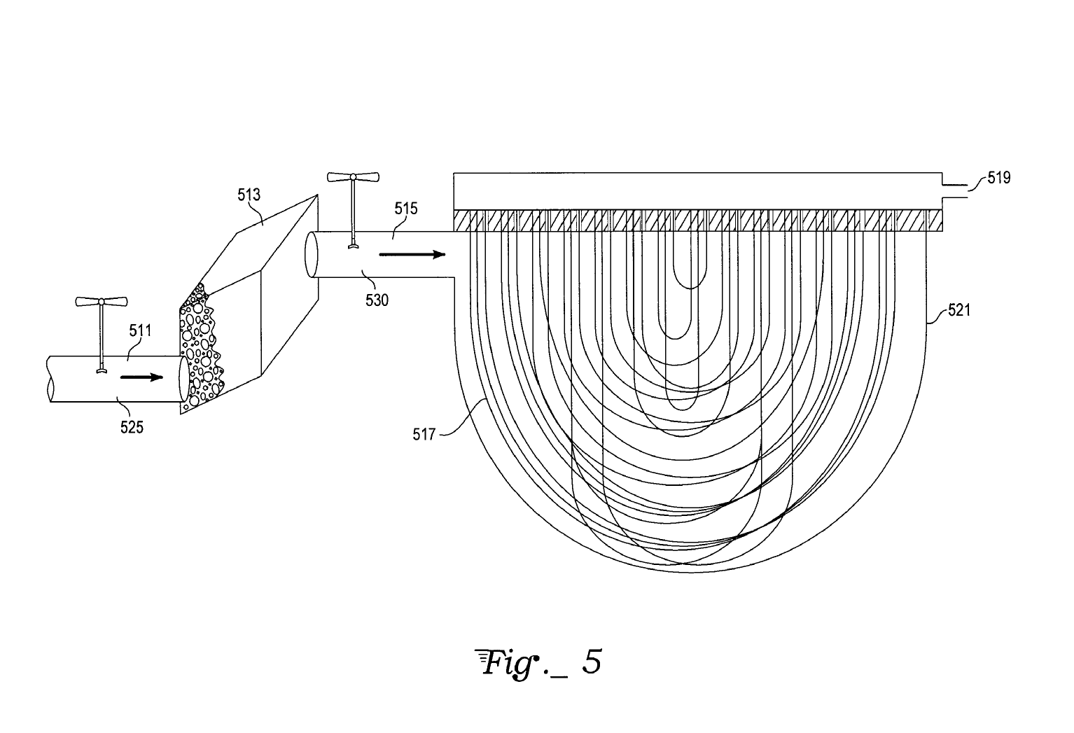

With respect to FIG. 5, an embodiment is shown in which fluoride and other ionic contaminants are removed from water by passing the water (which contains ionic contaminants) through a housing containing iron oxide particles. This would convert the ionic fluoride into iron fluoride, which is only slightly soluble. The iron fluoride particles would then be retained on an ultrafiltration membrane and removed.

Referring to FIG. 5, the water flows through an inlet 511 into housing 513. Prior to entry into housing 513, the water could already have passed through a pre-filter that would remove larger particulate matter. Housing 513 holds oxidized iron (Fe₂O₃) in the form of an iron oxide material surface. The material is packed into housing 513 such that water may pass through the housing under the pressure of a hand pump. The surface of the iron oxide material allows for a reaction with the fluoride ions. The oxidized iron material may be, for example, a matted porous layer, a porous pile of oxidized iron mesh material, a network of iron ribbon material, or particulate matter, such has rusted ball bearings. The water must flow through this housing to enter into a cartridge. Alternatively, the oxidized iron material may be added into the cartridge itself. Oxidation of the material surface provides a coating of Fe₂O₃ (rust) on the surface of the iron material packed into housing 513. The oxidized iron material must be selected to provide sufficient surface area to allow the ionic reaction to take place while also allowing low pressure (hand pressure) pumping of the water through the filter. If iron ball bearings are used, the size may be 1-2 mm or the housing can be packed with fabric or fiber or other porous material coated with Ferric Hydroxide. If particles are used, a minimum size would be in no smaller than 125 um, about the lower limit of a fine sand.

Chemically, the reaction that takes place is believed to be:

Water containing fluoride ions+iron oxide=water with suspended iron fluoride (an insoluble salt)+hydroxyl ions (which would be soluble in water) Fe₂O₃+6F+3H₂O=6N(OH)-+2FeF₃

Water flowing out of housing 513 would flow into an inlet 515 into cartridge 521. As noted above, these cartridges contain a plurality of ultrafiltration membrane tubes 517 within cartridge 521. As noted above, this filtration membrane has the ability to remove submicron microns from the water. Also particles that are larger than a few microns would be removed from the water. This would include most scale particles from the oxidized iron surface. The purified water would leave the cartridge through exit passageway 519.

This process first binds ionic fluoride to oxidized iron before the water is further purified using an ultrafiltration membrane present as a network of ultrafiltration tubes. This ultrafiltration membrane filters out particles as small as a few microns, which would include most scale particles or particles of ferric fluoride. In other fluoride removal methods, the purification (e.g. clay, bone charcoal, etc.) would have to be removed and disposed of. The purification material could potentially release fluoride into a water source. In the present device and method, the iron fluoride collected from the filter would be in a much less soluble form and could be burned for disposal.

Fluoride ions in the water have an ion exchange reaction with the oxidized iron. This fixes the fluoride onto the surface of the iron as iron fluoride.

### EXAMPLE I

Water with about 4 ppm sodium fluoride was passed through 100 g of particulate oxidized iron particles (size 0.1 mm to 5 mm) contained within a chamber that allowed water flow through. The water was then filtered using an ultrafiltration membrane similar to those described above. The non-soluble iron fluoride percipitate that was produced was inhibited from passing through the ultrafiltration membrane. The suspended matter, which is retained on the surface of the ultra filtration membrane, shall be washed off periodically and fixed in a practically non-soluble matrix to avoid re intrusion of removed fluoride into the environment. The water which was filtered was reduced to a level of about 1 ppm fluoride.

The process for passing the water through the iron oxide requires taking into consideration the pressure of the water, the form of the iron oxide, the specific surface area/weight and weight of the iron oxide, consumption (reaction) of the iron oxide materials, and cost. The above example used iron oxide oval/round particles in granular form. This material was packed into a housing.

### EXAMPLE II

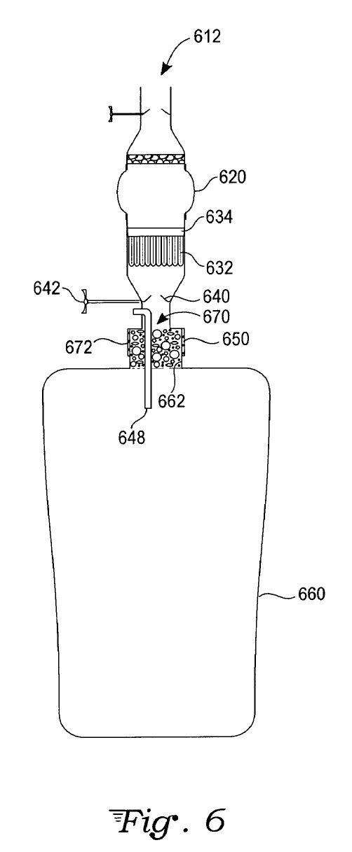

Other embodiments are envisioned. For example, with regard to FIG. 6, a water bottle is shown having a water bottle housing 660 and a threaded neck 650. In to the threaded neck is placed an insert 670 containing iron particles 672 held by mesh 674. This insert 670 may be retained on the mouth of the bottle and removed when the bottle is filled. The water to be consumed would be drawn through the iron oxide material 672, past valve 640 (having valve knob 642) through ultrafiltration membranes 632 held by retainer 632, through chamber 660 and out open end 612. A tube 648 could allow the bottle to be flushed, preventing excessive backpressure. This embodiment is further disclosed in U.S. patent application Ser. No. 12/020,177, hereby expressly incorporated by reference herein.

### EXAMPLE III

A hand pump, such as a MARK II style hand pump, is able to provide sufficient amounts of water to allow a single pump to provide a small community sufficient drinking water. As shown in 7, this pump would include ground supports 776 and in intake tube 744. The pump mechanism 738 is driven by arm 742. A pivot linkage 762 may drive a second pump 740 by means of arms 760 and pivot linkages 768, 764 and 770. One these pivot linkages is attached to fixed mount 766.

Water pumped by this pump flows into reservoir 746, and flows into pipe 748. The water then flows into tube 772, which it is driven by pump 740 through iron oxide particles 750 contained in tube 755, through pipe 778, and through ultrafiltration cartridges 752, 754. The water flowing from tube 756 has been purified and is drinkable. If excess water is pumped, or if backpressure occurs, the excess water can flow from tube 774, and be used for purposes other than drinking, such as irrigation.

It is believed that to treat water having 4 ppm fluoride, 100 grams of iron oxide should be sufficient to treat 15,000 liters of water. Iron oxide in the range of 0.1 gram to 10 grams per 1000 liters of water is projected to have a positive effect on removing fluoride from the water, and allowing subsequent removal of the precipitated fluoride on the ultrafiltration membrane. The size of the chamber containing the iron oxide may be manufactured to specific designs. The size of iron oxide particles is sufficiently great to allow water flow under low pressure (for example, at about 50 liters/hour flow rate) as would be produced by a hand pump. In any of the embodiments of FIGS. 3, 4, and 5, the iron oxide compartment or chamber could be included as part of the ultrafiltration cartridge. Alternatively the iron oxide may be a separate chamber. This chamber may have a valve (such as valves 530, 525 in FIG. 5) to allow the iron oxide material chamber to be rapidly detached and replaced. It also may be desired to periodically regenerate the iron oxide on the surface of particles. This may be done by physical abrasion, chemical treatment (e.g. strong acid treatment, or other means).

What is claimed is:

1. A water filtration device comprising:
a water intake;
an enclosed chamber holding iron oxide material configured such that water flowing through said intake will flow through the iron oxide material;
an ultrafiltration cartridge containing a plurality of ultrafiltration membrane tubes disposed within a cartridge that water flows through walls of said ultrafiltration membrane tubes, into an interior of said ultrafiltration tubes and out an open end of said ultrafiltration membrane tubes, wherein the open ends are secured through a barrier layer that prevents unfiltered water from mixing with filtered water; and
an outlet from said cartridge on a side of said barrier layer having the open ultrafiltration membrane tubes ends.

2. The water filtration device of claim 1, wherein the iron oxide material are ball bearings.

3. The water filtration device of claim 1, wherein the iron oxide material is an oxidized iron particulate material no smaller than 125 um.

4. The water filtration device of claim 1, wherein said enclosed chamber is integrated into said housing.

5. The water filtration device of claim 1, wherein said enclosed chamber is separately removable from said housing.

6. A method for removing contaminants from drinking water comprising:
filtering water through an iron oxide material;
pumping water which has passed through said iron oxide material through a plurality of ultrafiltration membrane tubes, wherein water flows through the walls and into the interior of the ultrafiltration membrane tubes and may exit open ends of said ultrafiltration tubes, wherein said walls and said ends are separated by a water impermeable barrier; and
removing filtered water from a side of the water impermeable barrier.
